(19) United States
(12) Patent Application Publication
(10) Pub. No.: US 2005/0136893 A1
(43) Pub. Date: Jun. 23, 2005

(54) Terminal and method for transmitting electronic message with user-defined contents

(76) Inventors: Timo Ala-Lehtimaki, Oulu (FI); Andreas Bork, Ulm (DE)

Correspondence Address: CRAWFORD MAUNU PLLC, 1270 NORTHLAND DRIVE, SUITE 390, ST. PAUL, MN, 55120, US

(21) Appl. No.: 10/743,374

(22) Filed: Dec. 22, 2003

(51) Int. Cl. H04M 3/16

(52) U.S. Cl. 455/412.1; 455/575.1

(57) ABSTRACT

A terminal of a radio communication system for transmitting an electronic message with user-defined contents, and a method for transmitting an electronic message with user-defined contents utilizing a terminal of a radio communication system. The terminal includes a wireless transceiver, a user interface element, and a processing unit. The processing unit is coupled to the wireless transceiver and the user interface element. The processing unit is configured to receive an input defining the contents of the electronic message from the user interface element, to receive a shorthand for a destination of the electronic message from the user interface element, to associate the shorthand for the destination with a full destination, and to transmit the message with user-defined contents to the full destination utilizing the wireless transceiver.

### FIELD

The invention relates to a terminal of a radio communication system for transmitting an electronic message with user-defined contents, and to a method for transmitting an electronic message with user-defined contents utilizing a terminal of a radio communication system.

### BACKGROUND

The use of mobile telephones is widely spread. Text messages, which can be sent and received using mobile telephones, have become very popular. Other types of messages are also evolving, such as messages containing multimedia information. While sending such a message, it is annoying and time consuming to enter a mobile telephone number of a recipient of the message. Either the mobile telephone number must be remembered, or it must be searched through an internal phone book of the mobile telephone.

### BRIEF DESCRIPTION OF THE INVENTION

The present invention seeks to provide an improved terminal of a radio communication system for transmitting an electronic message with user-defined contents, and an improved method for transmitting an electronic message with user-defined contents utilizing a terminal of a radio communication system.

According to an aspect of the present invention, there is provided a terminal of a radio communication system for transmitting an electronic message with user-defined contents, the terminal comprising: a wireless transceiver: a user interface element, and a processing unit coupled to the wireless transceiver and the user interface element, configured to receive an input defining the contents of the electronic message from the user interface element, to receive a shorthand for a destination of the electronic message from the user interface element, to associate the shorthand for the destination with a full destination, and to transmit the message with user-defined contents to the full destination utilizing the wireless transceiver.

According to another aspect of the present invention, there is provided a terminal of a radio communication system for transmitting an electronic message with user-defined contents, the terminal comprising: wireless transmitting means for transmitting an electronic message with user defined contents; user interface means for interacting with a user of the terminal; and processing means for receiving an input defining the contents of the electronic message from the user interface means, for receiving a shorthand for a destination of the electronic message from the user interface means, for associating the shorthand for the destination with a full destination, and for transmitting the message with user-defined contents to the full destination utilizing the wireless transmitting means.

According to another aspect of the present invention, there is provided a method for transmitting an electronic message with user-defined contents utilizing a terminal of a radio communication system, the method comprising, receiving an input defining the contents of the electronic message; receiving a shorthand for a destination of the electronic message; associating the shorthand for the destination with a full destination; and transmitting the message with user-defined contents to the full destination.

The present invention provides several advantages. The invention makes it easier to input a destination of messages with user-defined contents. The invention is not restricted to the use of keys but it may be applied to other, perhaps more futuristic, user interface elements as well.

### LIST OF DRAWINGS

In the following, the invention will be described in greater detail with reference to the embodiments and the accompanying drawings, in which

FIG. 1 shows an example of the appearance of a terminal;

FIG. 2 is a simplified block diagram illustrating parts of a typical terminal;

FIG. 3 illustrates how an electronic message with user-defined contents may be transmitted;

FIG. 4 is a screen shot sequence illustrating how a shorthand feature may be set on;

FIG. 5 is a screen shot sequence illustrating how a shorthand for a destination may be set;

FIG. 6 is a screen shot sequence illustrating how a shorthand for a destination may be used for transmitting a message with user-defined contents; and

FIG. 7 is a flow chart illustrating a method for transmitting an electronic message with user-defined contents utilizing a terminal of a radio communication system.

### DESCRIPTION OF EMBODIMENTS

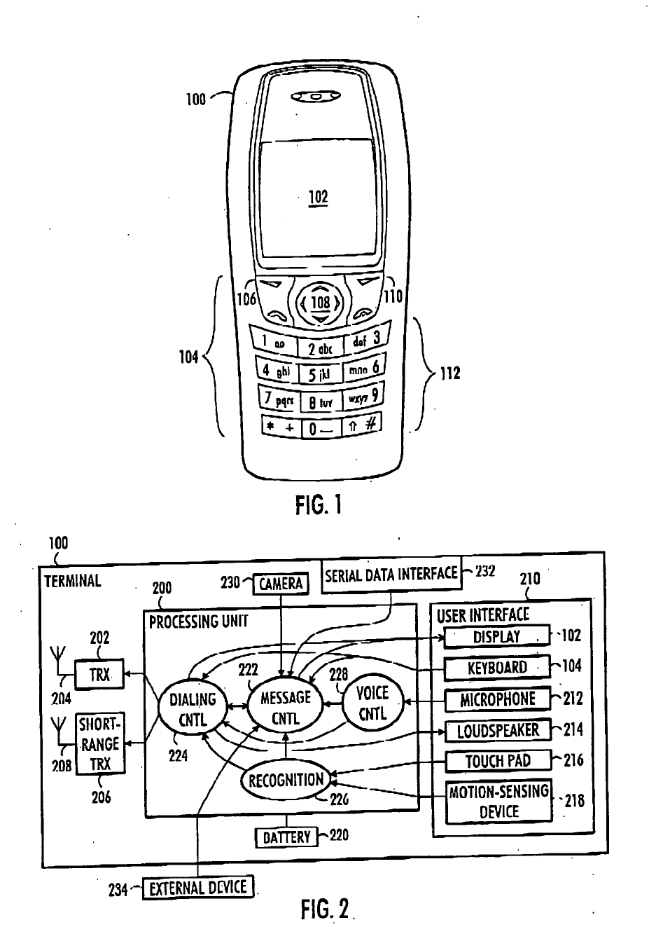

All example of the appearance of a terminal 100 of a radio communication system will be described with reference to FIG. 1. The exemplary terminal is a Nokia® 6610 phone. Such a terminal 100 includes a user interface with which a user interacts with the terminal 100. In the embodiment of FIG. 1, the user interface includes, among other things, a display 102 and A plurality of keys 104. The keys 104 may include 4-way scroll keys 108, combination keys 106, 110 and number and character keys 112. The combination key 106 includes a selection key and a dial/answer key. The other combination key 110 includes a selection key and a hang up key.

Next, the structure of the terminal will be described with reference to FIG. 2. The terminal 100 includes an antenna 204 and a transceiver 202. The transceiver 202 is e.g. a prior art radio frequency transceiver of a mobile station which functions in a GSM system (Global System for Mobile Communications), GPRS system (General Packet Radio Service) or in a UMTS system (Universal Mobile Telecommunications System), for instance. In addition to the above-mentioned keyboard 104 and display 102 for implementing a user interface 210, the terminal 100 may include a microphone 212 and a loudspeaker 214 for processing sound. A chargeable battery 220 may function as the power source.

Also other technologies known in the art may be used for implementing the user interface 210. Such technologies include a touch pad 216, a motion-sensing device 218, and a voice control 228, for example. The use of these and other user interface techniques will be explained later. In summary, the user interface 210 includes a number of user interface elements, 102, 104, 212, 214, 210, 218, some of which may be optional.

The terminal 100 may also include, besides the cellular radio network transceiver 202, another wireless transceiver 206, which may also use an antenna 208. Such an other wireless transceiver 206 may be a short-range radio transceiver, such as a Bluetooth™ transceiver, a Wireless Local Area Network WLAN transceiver, or an infrared transceiver, such as an infrared transceiver according to the IrDA (The Infrared Data Association) standard, or any other known wireless transceiver utilizing electric and/or magnetic waves. WLAN may be as defined by standards in the 802.11 series of the IEEE (The Institute of Electrical and Electronics Engineers, Inc.) for example. An access point, or a service access point as it is also known, forms an access zone of the WLAN system. An access zone is also known as a hotspot. It is an area, such as an office, a university campus, a hotel or an airport, for example, where fast LAN-connections are offered to the users. Access to the Internet may be realized through the access point. Bluetooth™ technology may use a radio link covering at most a few hundred meters at a frequency of 2.4 gigahertz.

The terminal 100 further includes a processing unit 200, which controls and monitors the operation of the terminal 100 and its various parts. The processing unit 200 may also include the application programs of the terminal 100, e.g. for radio signal processing and user interface 210 management. Nowadays the processing unit 200 is usually implemented as a processor and its software but various hardware solutions are also feasible, such as a circuit built from separate logic components or one or more application-specific integrated circuits (ASIC). If necessary, there may be more than one processor. A hybrid of these solutions is also feasible. In the selection of the implementation a person skilled in the art will naturally consider the requirements set for the size and power consumption of the terminal 100, the necessary processing capacity, production costs and production volumes, for example.

A terminal 100 of a radio communication system for transmitting an electronic message with user-defined contents, as illustrated in FIGS. 1 and 2, thus includes a wireless transceiver 202, 206, a user interface element 102, 104, 212, 214, 216, 218, and a processing unit 200. The processing unit 200 is coupled to the wireless transceiver 202, 206 and the user interface element 102, 104, 212, 214, 216, 218.

The processing unit 200 is configured to receive an input defining the contents of the electronic message from the user interface element 104, 212, 216, 218. The electronic message with user-defined contents may be a data message, for example. The electronic message with user-defined contents includes a text message, a Short Message Service SMS message, a Multimedia Message Service MMS message, an e-mail message, or other electronic messages used to convey non-real-time information, for example.

The fact that the input defines the contents of the electronic message does not necessarily imply that the input itself constitutes the sole contents of the message. The electronic message with user-defined contents may include a text message created with the user interface element 104, 212, 216, 218. The electronic message may also include a digital image or drawing created by means of a camera 230 or touch pad 210 coupled to the terminal 100. The electronic message may also include a digital sound recording, a digital representation of sound, or some other file. The electronic message may also include data inputted over a serial data interface 232. The electronic message may also include material inputted to the terminal 100 from a device 234 external to the terminal 100.

The processing unit 200 is also configured to receive a shorthand for a destination of the electronic message from the user interface element 104, 212, 216, 218, and to associate the shorthand for a destination with a full destination. The electronic message may be sent to different kind of destinations. The full destination may define a subscriber identifier of the radio communication system, such as a Mobile Subscriber International Integrated Services Digital Network ISDN number MSISDN. The full destination may also define a group of subscriber identifiers of the radio communication system. The full destination may also be an e-mail address or a group of e-mail addresses. The full destination may also define another terminal of the radio communication system, with an International Mobile Subscriber Identity, for example. The full destination may also define a computer or an Internet Protocol IP address.

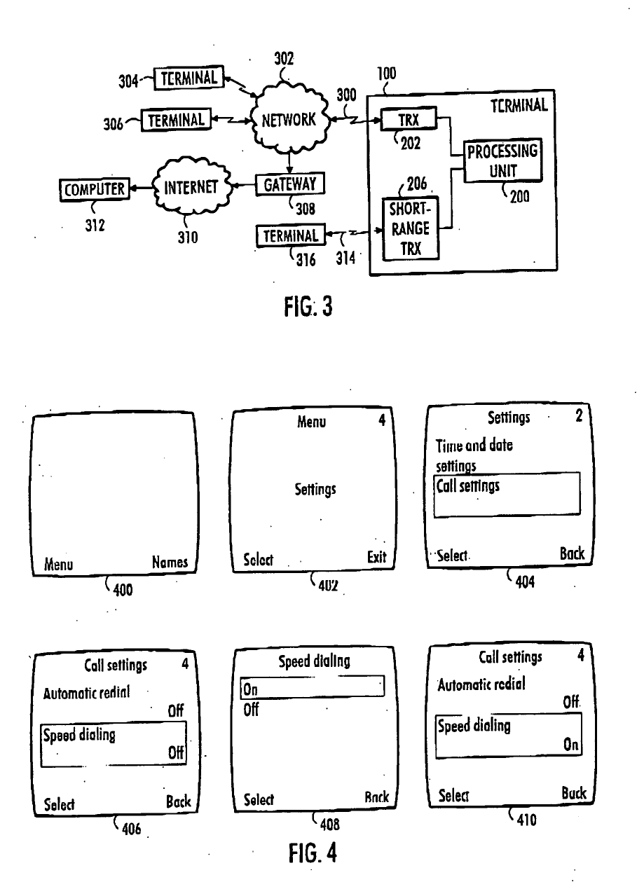

The processing unit 200 is further configured to transmit the message with user-defined contents to the full destination utilizing the wireless transceiver 202, 206. FIG. 3 illustrates how the electronic message with user-defined contents is transmitted. As explained earlier, the terminal 100 may include at least one wireless transceiver 202, 206 coupled to the processing unit 200. In the first scenario, the electronic message is transmitted via a cellular radio network 302 to at least one terminal 304, 306. In the second scenario, the electronic message is transmitted, possibly via a message conversion gateway 308, and possibly via the Internet 310, to at least one computer 312. The message conversion gateway 308 may perform a conversion from the cellular radio network form into a computer network format, for example. In the third scenario, the electronic message is transmitted to another terminal 316 without using the described radio path 300, but with a possibly free of charge connection 314, such as a short-range radio connection, a Bluetooth™ connection, an infrared connection, an IrDA connection, or a WLAN connection. The WLAN connection may necessitate the use of the WLAN system, through the above-mentioned access point, for example.

FIG. 2 also illustrates an exemplary structure of the processing unit 200. Blocks 222, 224, 226, 228 belonging to the processing unit 200 are structural entities that can be implemented e.g as program modules. i.e. by a programming language, such as the C programming language, C++ programming language, some other computer language, or by an assembler, which are stored as runnable versions in a memory provided in the processor and run in the processor. Instead of translatable programming languages, other interpretable progamming languages may naturally also be used, provided that they satisfy the required processing rate and capacity.

When the processing unit 200 is implemented as an ASIC, the structural entities 222, 224, 226, 228 may be ASIC blocks.

In the embodiment of FIG. 2, the processing unit 200 in eludes the following blocks: a message control block 222 responsible for the composition of the message with user-defined contents, a dialing control block 224 responsible for associating the shorthand for the destination with the full destination and for the actual dialing. The processing unit 200 may also include two other blocks, a recognition block 226 and a voice control block 228, which will be explained later.

Naturally the processing unit 200 may include numerous other blocks, such as a general control block, a user interface control block, etc. Such other blocks are well known to a person skilled in the art and need not be further described here.

Next, an elaborated example is given on the use of a shorthand for a destination with reference to screen shots of FIGS. 4, 5 and 6. In the embodiment of FIGS. 4, 5 and 6, the user interface element includes a plurality of keys 104, and the processing unit 200 is configured to receive key presses, which represent the shorthand for the destination. ‘Speed dialing’ refers to the use of the shorthand for the destination. FIG. 4 is a screen shot sequence illustrating how a shorthand feature is set on. The user selects ‘Menu’ if in 400. Next, the user selects ‘Settings’ in the ‘Menu’ in 402. Next, the user scrolls down to select. ‘Call settings’ in 404. Next, the user scrolls down to select ‘Speed dialing’ in 406. As illustrated in 406, the speed dialing is currently set off. The user sets the speed dialing on in 408, and then returns to the ‘Call settings’. The ‘Call settings’ are shown in 410. Note that speed dialing is now set on.

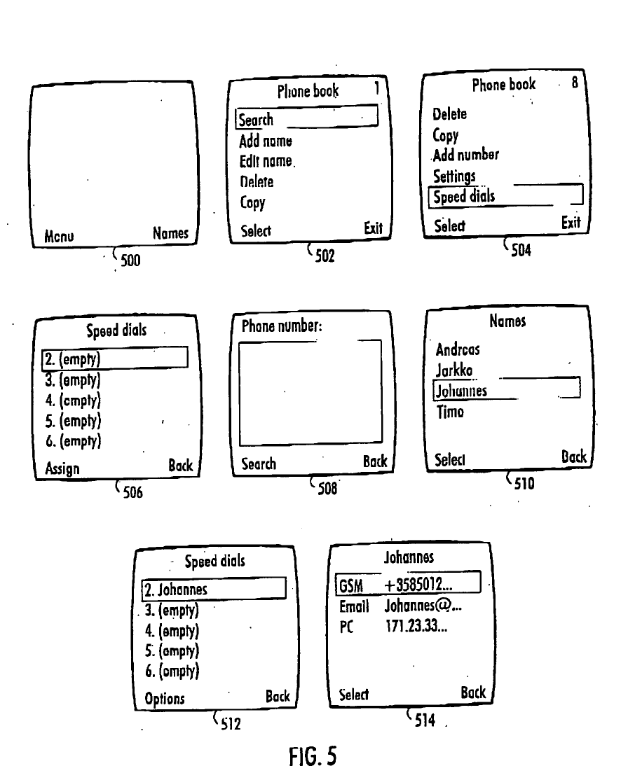

FIG. 5 is a screen shot sequence illustrating how the shorthand for the destination is set. The user selects ‘Names’ in 500. Next, the user is shown the screen 502. The user scrolls down to ‘Speed dials’ and selects it in 504. The user is then shown the list of assigned speed dials in 506. Speed dials can be set to eight number keys 112, i.e. keys ‘2’, ‘3’, ‘4’, ‘5’, ‘6’, ‘7’, ‘8’ and ‘9’ of our exemplary terminal illustrated in FIG. 1. As illustrated in the screen 506, there are no speed dials set initially, The user selects ‘Assign’ to set a full destination to the key ‘2’ in 508. Next, a screen 508 is shown to the user. The user selects ‘Search’ in 500 in order to search for information in the internal phone book of the terminal, A part of the phone book is shown in 510: it includes four names. ‘Andreas’, ‘Jarkko’, ‘Johannos’ and ‘Timo’. The user scrolls down to select ‘Johannes’ in 310. Next, the user performs the ‘Select’ operation for ‘Johannes’ in 510. Finally, the user is shown a screen 512: as illustrated, key ‘2’ now has a shorthand for a destination associated with it. The selected addressing detail associated with key ‘2’ is the full destination of ‘Johannes’. In an embodiment, the shorthand for the destination includes a speed dialing number, which includes a plurality of dialing digits.

Depending on the amount and types of addressing details, another submenu may be displayed after the screen 510 to select the desired addressing detail as the full destination. As illustrated in 514, ‘Johannes’ may have three full destinations: a GSM number, an e-mail address, and an Ip address. The user may select one or more of these full destinations, after which the screen 612 may be displayed.

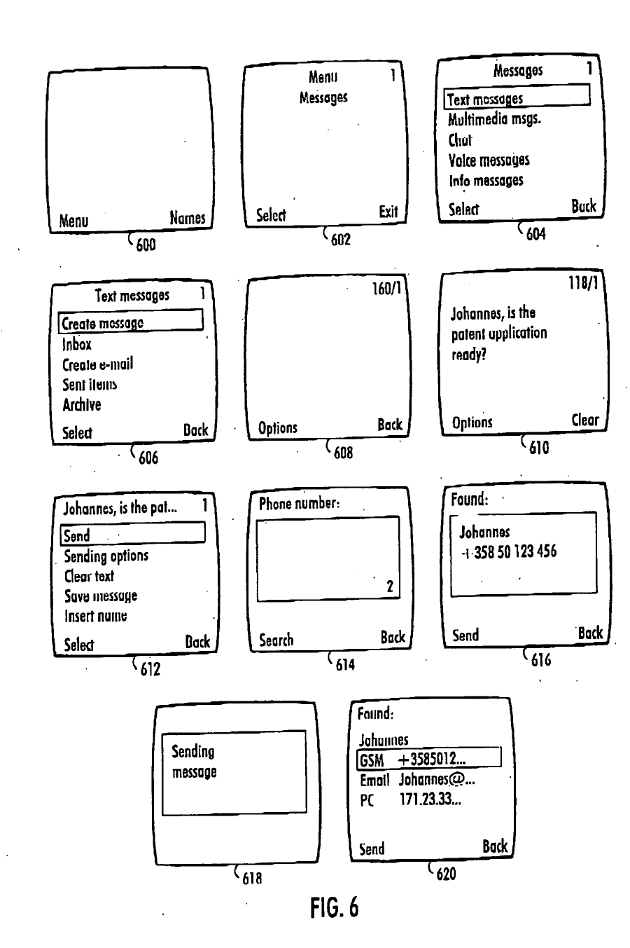

FIG. 6 is a screen shot sequence illustrating how the shorthand for the destination is used for transmitting a message with user-defined contents. The user selects ‘Menu’ in 600. Next, the user selects ‘Messages’ in 602. The user selects ‘Text messages’ in 604. ‘Create message’ is selected in 606. The screen 608 illustrates that the text message may include 160 characters. The user inputs the following message: ‘Johannes, is the patent application ready?’ as illustrated in screen 610. Next, the user selects ‘Send’ in 612. A window for the phone number appears as illustrated in 614. Nevertheless, the user does not need to input the whole telephone number; the user just performs a speed dialing selection of key ‘2’ as illustrated in 614.

In an embodiment, the processing unit 200 is configured to interpret a key press of a key associated with the shorthand lasting longer than a predetermined time as the shorthand for the destination. In another embodiment, the processing unit 200 is configured to interpret a key press of a key associated with the shorthand followed by a key press of another key as the shorthand for the destination. The other key may be a dial/answer key 100.

The processing unit 200 associates the shorthand for the destination (key press ‘2’) with the full destination (the full destination defined for ‘Johannes’). The success of the operation is shown to the user in 616. Next, the message may be sent automatically, or the user is required to select ‘Send’ or ‘Back’ as illustrated in 616. If the user selects ‘Send’, the message is sent as illustrated in 618, but if the user selects ‘Back’, the previous screen 614 may be shown to the user.

In an embodiment, several full destinations may be associated to one shorthand for the destination. After the user has selected the shorthand for the destination in 614, a screen 620 may be displayed to the user. As illustrated in 620, ‘Johannes’ has three full destinations: a GSM number, an e-mail address, and an IP address. The user may select one of these full destinations and then select ‘Send’, after which 618 is displayed. Another embodiment is such that the user has already selected the full destination, which is associated with ‘Johannes’, when setting the shorthand for the destination, as explained above in connection with the screen 514. Such an embodiment is also possible, wherein the user sets an order for the full destinations within the shorthand for the destination. When the order has been set, the message may first be transmitted to the first full destination. If this falls, the message may be transmitted to the second full destination, etc.

It is to be understood that FIGS. 4, 5 and 6 only illustrate one embodiment among the many possibilities to implement the shorthand for the destination functionality into the user interface 210 of the terminal 100 The terminal may be a subscriber terminal of a cellular radio system, but it may also be another kind of radio terminal, a WLAN terminal, for example. The terminal may also combine different functions, i.e. it may be a combination of a subscriber terminal and a PDA (Personal Digital Assistant), for example. An example of this kind of combined device is a Nokia® Communicator®.

In an embodiment, the user interface element includes a microphone 212, and the processing unit 200 is configured to recognize voice as the shorthand for the destination. The processing unit 200 may include a voice control block 228, which recognizes given voice commands. The terminal 100 may include a key, which has to be pressed at the same time a voice command is given. The user may press the key and say ‘Johannes’. The processing unit 200 recognizes this command as the shorthand for the destination, and transmits the message to ‘Johannes’. Nokia® 8310 phone uses voice tags, and the key that has to pressed while using them is a volume key or a selection key.

In an embodiment, the user interface element includes a touch pad 216, and the processing unit 200 is configured to recognize a special touch as the shorthand for the destination. The touch pad 216 may be integrated with the display 102. A combination of the touch pad 216 and the display 102 may be called a touch screen. A virtual keyboard may be shown on the touch pad 216, and the shorthand for the destination may be associated with a key of the virtual keyboard. Another solution is such that strokes made by the user on the touch pad 216 are recognized, and the shorthand for the destination may be associated with a specific stroke.

A solution is also possible where the topmost part is a touch pad 216, below which there may be a display 102, and the lowest part is a feedback unit, which provides tactile feedback. U.S. Pat. No. 5,977,667, U.S. 2003/0038776 and WO 03/038800, which are incorporated herein by reference, describe various solutions for giving tactile feedback. The touch pad 216 can be implemented by prior art solutions, which may be based on capacitive or resistive sensors. When the user touches the touch pad 210 with his or her finger, for example, the touched point and usually also the touch force may be determined. The display 102 may be implemented by prior art solutions; for example, if the display should be flat, a liquid crystal display (LCD), a plasma display or a thin film transistor display (TFT) can be used. The feedback unit providing tactile feedback may ha implemented by prior art solution, for example by a piezoelectric element or a linear vibrator based on a solenoid. The feedback unit generates a mechanical movement, which the user can sense through touch. The frequency, amplitude and duration of the movement may be controlled. The movement may be sensed as trembling and vibration. The movement may simulate a click generated by a key press, for example.

In an embodiment, the user interface element includes a motion-sensing device 218, and the processing unit 200 is configured to recognize a special motion as the shorthand for the destination. In one solution, the keyboard is implemented in an unusual manner: it is projected from the terminal 100 next to it, e.g. onto the air or onto a surface, such as a table surface. The terminal 100 thus employs prior art for presenting the keyboard and its keys as a projected image. The motion-sensing device 218 determines whether the user is pressing virtual keys of the projected keyboard, and the shorthand for the destination is associated with a key of the projected keyboard. The use of the projection technique is described in U.S. application 09/892000, which is incorporated herein by reference. In another solution, the motion-sensing device 218 includes an acceleration sensor (or accelerometer), which may detect the motion of the terminal 100 in one, two or even three dimensions.

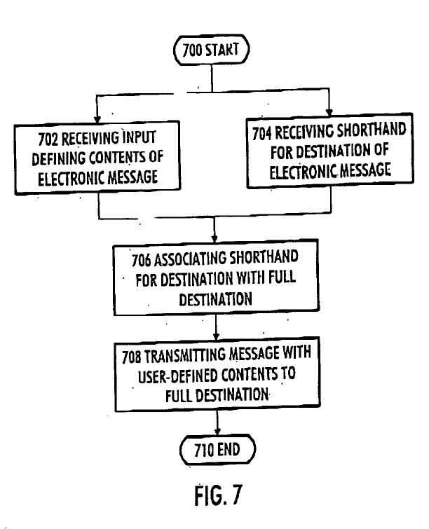

In the following, one method for transmitting an electronic message with user-defined contents utilizing a terminal of a radio communication system will be described with reference to FIG. 7 and as an example. The method starts in 700, e.g. when the subscriber terminal is switched on. If the user of the terminal wants to transmit a message with user-defined contents, two operations have to be performed first. The order of these operations is unimportant. These operations are: receiving an input defining the contents of the electronic message in 702, and receiving a shorthand for a destination of the electronic message in 704. Next, the shorthand for a destination is associated with a full destination in 706. Finally the message is transmitted with user-defined contents to the full destination in 708. The method ends in 710, e.g. when the subscriber terminal is switched off, or when the user no longer wishes to send messages with user-defined contents.

The terminal 100 described above is suitable for performing the method, but also other terminals capable of composing messages with user-defined contents, associating the shorthand for the destination with the full destination, and transmitting the message with user-defined contents to the full destination may be used. The method may be enhanced with the embodiments described above for the terminal 100.

In an embodiment, the reception 704 of the shorthand for the destination of the electronic message includes: receiving key presses, which represent the shorthand for the destination.

In an embodiment, the method further includes: interpreting a key press of a key associated with the shorthand lasting longer than a predetermined time as the shorthand for the destination. In another embodiment, the method further includes: interpreting a key press of a key associated with the shorthand followed by a key press of another key as the shorthand for the destination.

In an embodiment, the reception 704 of the shorthand for the destination of the electronic message includes: recognizing voice as the shorthand for the destination. In another embodiment, the reception 704 of the shorthand for the destination of the electronic message includes: recognizing a special touch of a touch-sensitive area of the terminal as the shorthand for the destination. In another embodiment, the reception 704 of the shorthand for the destination of the electronic message includes: recognizing a special motion as the shorthand for the destination.

As mentioned above, the message with user-defined contents may be composed using numerous different prior art ways. These include: creating a text message as the electronic message with user-defined contents; creating a digital image or drawing as the electronic message with user-defined contents; creating a digital sound recording as the electronic message with user-defined contents; creating a digital representation of sound as the electronic message with user-defined contents; creating a file as the electronic message with user defined contents; receiving data inputted over a serial data interface as the electronic message with user-defined contents; receiving material from a device external to the terminal as the electronic message with user-defined contents.

Even though the invention has been described above with reference to an example according to the accompanying drawings, it is clear that the invention is not restricted thereto but can be modified in several ways within the scope of the appended claims.

1. A terminal of a radio communication system for transmitting an electronic message with user-defined contents, the terminal comprising:
a wireless transceiver;
a user interface element; and
a processing unit coupled to the wireless transceiver and the user interface element, configured to receive an input defining the contents of the electronic message from the user interface element, to receive a shorthand for a destination of the electronic message from the user interface element, to associate the shorthand for the destination with a full destination, and to transmit the message with user-defined contents to the full destination utilizing the wireless transceiver.

2. The terminal of claim 1, wherein the user interface element includes a plurality of keys, and the processing unit is configured to receive key presses, which represent the shorthand for the destination.

3. The terminal of claim 2, wherein the shorthand for the destination includes a speed dialing number, which includes a plurality of dialing digits.

4. The terminal of claim 2, wherein the processing unit is configured to interpret a key press of a key associated with the shorthand lasting longer than a predetermined time as the shorthand for the destination.

5. The terminal of claim 2, wherein the processing unit is configured to interpret a key press of a key associated with the shorthand followed by a key press of another key as the shorthand for the destination.

6. The terminal of claim 1, wherein the user interface element includes a microphone, and the processing unit is configured to recognize voice as the shorthand for the destination.

7. The terminal of claim 1, wherein the user interface element includes a touch pad, and the processing unit is configured to recognize a special touch as the shorthand for the destination.

8. The terminal of claim 1, wherein the user interface element includes a motion-sensing device, and the processing unit is configured to recognize a special motion as the shorthand for the destination.

9. The terminal of claim 1, wherein the electronic message with user-defined contents includes a data message.

10. The terminal of claim 1, wherein the electronic message with user-defined contents is one of a text message, a Short Message Service SMS message, a Multimedia Message Service MMS message, an e-mail message.

11. The terminal of claim 1, wherein the electronic message with user-defined contents is one of a text message created with the user interface element, a digital image or drawing created by means of a camera or a touch pad coupled to the terminal, a digital sound recording, a digital representation of sound, a file, data inputted over a serial data interface, material inputted to the terminal from a device external to the terminal.

12. The terminal of claim 1, wherein the full destination defines one of a subscriber identifier of the radio Communication System, a group of subscriber identifiers of the radio communication system, an a-mail address, a group of email addresses, another terminal of the radio communication system, a computer, an Internet Protocol IP address.

13. The terminal of claim 1, wherein the wireless transceiver includes a cellular radio network transceiver, a short-range radio transceiver, a Wireless Local Area Network WLAN transceiver, an infrared transceiver.

14. A terminal of a radio communication system for transmitting an electronic message with user-defined contents, the terminal comprising:
wireless transmitting means for transmitting an electronic message with user-defined contents;
user interface means for interacting with a user of the terminal; and
processing means for receiving an input defining the contents of the electronic message from the user interface means, for receiving a shorthand for a destination of the electronic message from the user interface means, for associating the shorthand for the destination with a full destination, and for transmitting the message with user-defined contents to the full destination utilizing the wireless transmitting means.

15. The terminal of claim 14, wherein the user interface means include keying means, and the processing means are configured to receive key presses, which represent the shorthand for the destination.

16. The terminal of claim 14, wherein the user interface means include voice-capturing means, and the processing means are configured to recognize voice as the shorthand for the destination.

17. The terminal of claim 14, wherein the user interface means include touch-sensing means, and the processing means are configured to recognize a special touch as the shorthand for the destination.

18. The terminal of claim 14, wherein the user interface means include motion-sensing means, and the processing means are configured to recognize a special motion as the shorthand for the destination.

19. A method for transmitting an electronic message with user-defined contents utilizing a terminal of a radio communication system, the method comprising:
receiving an input defining the contents of the electronic message;
receiving a shorthand for a destination of the electronic message;
associating the shorthand for the destination with a full destination; and
transmitting the message with user-defined contents to the full destination.

20. The method of claim 19, wherein the reception of the shorthand for the destination of the electronic message includes:
receiving key presses, which represent the shorthand for the destination.

21. The method of claim 20, wherein the method further comprises:
interpreting a key press of a key associated with the shorthand lasting longer than a predetermined time as the shorthand for the destination.

22. The method of claim 20, wherein the method further comprises:
interpreting a key press of a key associated with the shorthand followed by a key press of another key as the shorthand for the destination.

23. The method or claim 19, wherein the reception of the shorthand for the destination of the electronic message includes:
recognizing voice as the shorthand for the destination.

24. The method of claim 19, wherein the reception of the shorthand for the destination or the electronic message includes:
recognizing a special touch of a touch-sensitive area of the terminal as the shorthand for the destination.

25. The method of claim 19, wherein the reception of the shorthand for the destination of the electronic message includes:
recognizing a special motion as the shorthand for the destination.

26. The method of claim 19, wherein the method further comprises at least one of:
creating a text message as the electronic message with user-defined contents;
creating a digital image or drawing as the electronic message with user-defined contents;
creating a digital sound recording as the electronic message with user-defined contents;
creating a digital representation of sound as the electronic message with user-defined contents;
creating a file as the electronic message with user defined contents;
receiving data inputted over a serial data interface as the electronic message with user-defined contents;
receiving material from a device external to the terminal as the electronic message with user-defined contents.
